(19) United States
(12) Patent Application Publication
(10) Pub. No.: US 2016/0075149 A1
(43) Pub. Date: Mar. 17, 2016

(54) Method for Producing a Digitally Printed Decorative Coating on a Solid Surface

(71) Applicant: JETRONICA LIMITED, Cambridge (GB)

(72) Inventors: Albert Kocsis, Budapest (HU); Gusztáv Flórián, Dunakeszi (HU); Péter Kocsis, Budapest (HU)

(73) Assignee: JETRONICA LIMITED, Cambridge (GB)

(21) Appl. No.: 14/786,321

(22) PCT Filed: Apr. 23, 2014
(86) PCT No.: PCT/HU2014/000033

§ 371 Date: Oct. 22, 2015

(30) Foreign Application Priority Data
Apr. 24, 2013 (HU) P1300249

(51) Int. Cl. B41J 11/00

(52) U.S. Cl. CPC B41J 11/0015

(57) ABSTRACT

Method for producing a digitally printed decorative coating on a solid surface, comprising the steps of: applying solid pigment dye (2) to the surface (1) and treating the coating such that the treatment results in the setting/hardening of the coating, where at first the dry surface (1) is evenly coated applying solid pigment dye (2) at least over the surface portion where the coating is to be applied, in a subsequent printing operation liquid is applied to the surface (1) coated with dry pigment dye (2), thereby temporarily fixing the solid pigment dye (2) to the printed-on surface portions, and before performing the treatment resulting in the setting/hardening of the coating, removing the non-fixed portion of the solid pigment dye (2) from the surface (1).

The invention relates to a method for producing a digitally printed decorative coating on a solid surface, particularly on the surface of objects made of ceramics and glass.

Advances in computer technology have called for the development of digitally driven printing methods. Developments in the field soon took multiple directions. The most important conventional methods are the following (the list is non-exhaustive):
xerographic systems (laser and LED printers),
DOD (drop-on-demad) inkjet technology, based on ejecting liquid paint based on a thermal (HP, CANON), or volume displacement (piezo) principle (Epson, XAAR, Spectra),
CIJ (Continuous Ink Jet), wherein the paint is conveyed to the target surface applying a continuous flow of fluid that is divided into droplets by ultrasonic means, the droplets being electrostatically deflected (e.g. Imaje).

Most of the above listed systems were initially developed primarily for so-called “desktop printers” capable of printing a low number of copies. The demand for industrial-scale digital printing appeared in the 1990's, first induced by large-format poster prints, and then by textile decoration. What these two fields had in common was that small-format printing systems could be easily adapted to them with relatively few changes in construction because the applied paint materials were almost identical to those that had been used previously (solution paints, inks containing organic pigment).

Since paints are liquid-solid mixtures, and thus the danger of paint deposition and drying-in is always present, the chemical and physical characteristics of paints are very important. It is also important to maintain the penetrability of the thin channels of the print head. These factors pose especially serious problems if the paint material contains abrasive, high-density inorganic pigments, such as do ceramic paints.

The limitations of conventional liquid jet (inkjet) systems, as well as the above mentioned industrial requirements, have been a concern for experts working in the field for a long time.

In the document EP 0 703 863 B1 a solution is described by Benoit Brault wherein only the binding material is conveyed to the surface during the printing operation, the dry material being applied to the workpiece independent of the print head in a subsequent step, the dry material becoming adhered to the binding material on the surface. Glueing material is applied by the print head in solution form, and thus the above mentioned drying-in and deposition processes have to be counted with.

In the document US 2004/0101619 A1, Carlo Camorani describes a method wherein the printing operation basically directs only the binding material to the surface. The pigment is intended to be fed into the liquid jet before it would reach the surface. To achieve that, several variations are suggested in the document which is a combination of several earlier applications (it claims the priority of eight Italian applications). Difficulties caused by drying-in and plugging seem likely to occur also in this case, and the implementation of the interactions required between the binding material and the pigments in the free jet or on the surface is a complex and problematic task.

Neither of these systems have become widespread in industrial practice, although a need for a reliable digital printing method for ceramic purposes has been present for the past 10-15 years.

We have set as a goal to provide a method wherein the problems related to abrasion and plugging do not occur even if inorganic pigment is applied, and thereby digitally printed decorative coatings may be produced reliably and in a cost-effective manner.

The goal is achieved based on the recognition that the solid pigment dye is conveyed to the dry target surface while the solid pigment dye is dry, and printing is carried out on the layer thus produced.

The method according to invention is defined in claim 1, the preferred embodiments being defined in the dependent claims.

The invention will now be described in detail referring to the accompanying drawings, where

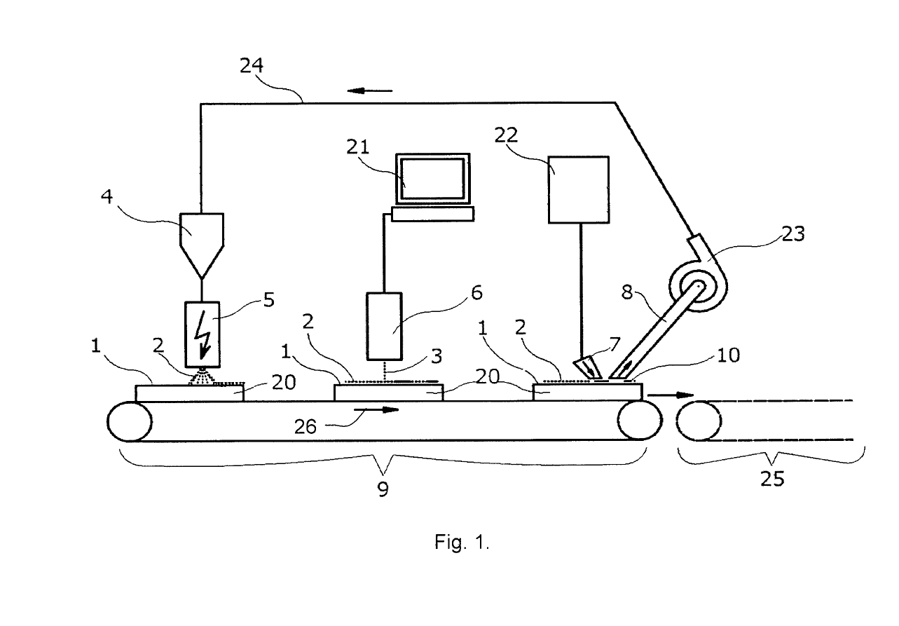

FIG. 1 shows the schematic view of the apparatus carrying out the method,

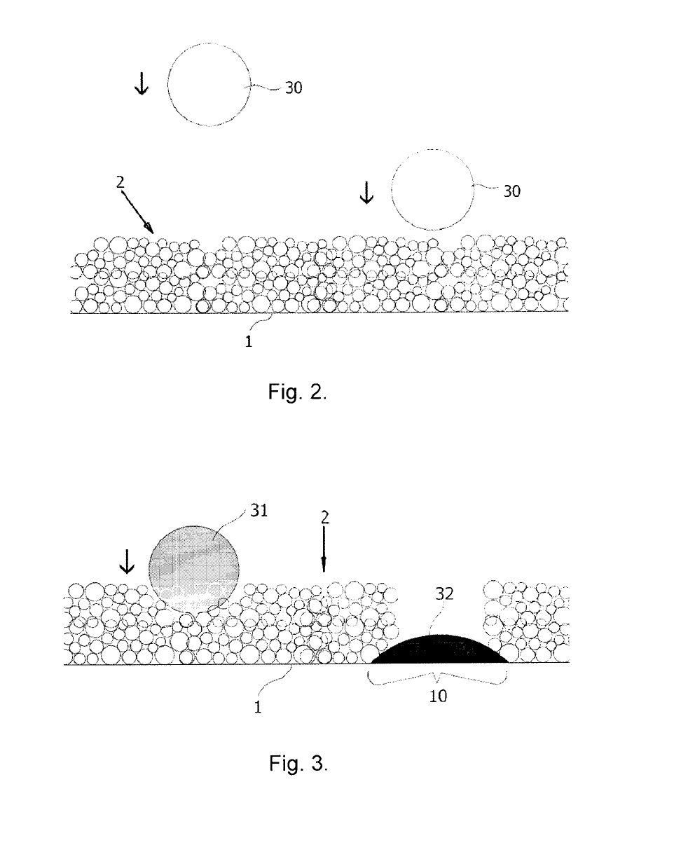

FIG. 2 is a schematic sectional view illustrating the layer of dry pigment powder on the surface of the object, and also showing the liquid droplets flying towards the powder layer in the instant before their impact, and

FIG. 3 shows the same sectional view as shown in FIG. 2, further illustrating the penetration of a liquid droplet through the powder layer, and also the state after the impact.

By way of example, a system applicable for decorating ceramic objects is described wherein solid pigment dye is mixed with a liquid on the solid target surface (made e.g. of ceramics). The liquid is utilised exclusively for fixing the solid particles to the surface temporarily, until after the ceramic plate is fired.

The method according to the invention can be divided into three stages:
distributing the pigment material evenly over the surface,
printing utilising a liquid free from solid materials (e.g. distilled water),
removing particles that have not been adhered to the surface.

Accordingly, the major constituent parts of the apparatus carrying out the method are
a coating unit that consists of a powder feeder unit 4 and an electrostatic charger unit 5 and is adapted for conveying the dry pigment dye 2 onto the surface 1,
a printing unit that consists of a printer 6 connected to a print controller 21 and is adapted for utilising a liquid 3 for printing on the surface 1 coated with dry pigment dye 2, and
an excess powder removal unit that consists of an air blower 7 and an extractor 8 and is supplied by a compressor 22, an extractor fan 23 being applied for returning the portion of the dry pigment dye 2 that was not fixed to the surface during the printing operation to the powder feeder unit 4 through an excess powder return duct 24.

In FIG. 1 a workpiece 20, such as a ceramic plate comprising a surface 1 to be coated is shown under all of the three major units of the apparatus. To achieve the relative displacement between the functional units and the workpieces in the direction of the arrow 26 a conveyor 9 is applied, with a further conveyor 25 being applied for transferring the painted-on workpieces 20 from the conveyor 9. Workpieces 20 arriving in the coating unit have no coating on their surface, while the surface 1 of workpieces 20 leaving the coating unit and entering the printing unit is coated with dry pigment dye 2. The surface 1 of workpieces 2 leaving the printing unit and entering the excess powder removal unit is partially coated with dry pigment dye 2, the workpieces 2 also having printed-on surface portions 10, with the workpieces 2 leaving therefrom and arriving at the second conveyor 25 (not shown) having printed-on surface portions 10, while those surface portions that have not been printed on have no coating.

In case multiple dry pigment dye 2 layers are applied one after the other for colour printing, the workpiece 20 is moved to conveyor 9 applying conveyor 25. The ready-printed workpiece 20 is then conveyed to a known drying and/or firing station utilising the conveyor 25.

The individual operations are presented below in more detail:

Application of the Dye

The application of the dry pigment dye 2 material to the surface 1 (target surface) in a uniform and reproducible manner is of key importance for the success of the process, as the achievable colour intensity is predominantly determined by the amount of applied dye material per area unit. Simple mechanical spraying of the dye powder is obviously not an adequate solution because the coating thus produced would not be uniform due to micro-level unevenness caused by the tendency of dye particles to form “conglomerates”, and also due to the macro-level nonuniformities resulting from the difficulties of powder feeding.

The solution involving electrostatic powder coating technology is applicable in our case without problems because it can be utilised for the fluidized transport of powdered materials applying a temporarily stable stationary process, and thereby the surface distribution may be well controlled. At the same time, electrostatic charging of powder particles results in a repulsing action between individual floating powder particles, with the particles being attracted towards the target surface, resulting in a uniform distribution on the micro-level, as well as in the temporary fixing of the particles to the surface.

In case the ceramic dye (pigment) is prepared in a way similar to that applied for dyes used in electrostatic powder coating (by adjusting the optimum particle size and shape, and forming suitable enveloping surfaces on the particles), the technological know-how related to these tried-and-tested systems may be taken advantage of for designing the coating process. Pigment particles are conveyed to the vicinity of the target surface either applying a suitably adjusted compressed air flow, or utilising gravity. Particles become electrostatically charged there, applying a properly configured electrode, and then the target surface is coated by the particles in a uniform manner.

It is preferable for carrying out the method if
conglomerated powder particles are separated applying ultrasonic or variable-frequency mechanical oscillations;
a loose powder layer is formed, which can be (completely or partially) penetrated by the liquid droplet 30 having a predetermined velocity;
a powder having a predetermined particle size distribution is applied;
a powder material including anti-agglomeration agent is applied;
the applied powder material is ceramic paint or glass paint;
a thermoplastic powder material that becomes plastic during firing by heat treatment is applied;
a powder material comprising biologically active material is applied;
a powder material comprising electrically conductive material is applied;
a powder material comprising a mixture consisting of materials soluble and insoluble by the liquid droplet 30 is applied;
a powder material partially or fully soluble in the liquid is applied.

Printing, Local Fixing of the Pigment

The digitally prepared image is printed on the pigment layer applied to the target object utilising water (or, alternatively, utilising other liquids or mixtures).

Penetrating through the powder layer formed by dry pigment dye 2 the liquid droplet 30 collects powder particles (as liquid droplet 31), and then places the particles on the substrate formed by the surface 1 (as liquid droplet 32). A printed-on surface portion 10 is thus produced.

In case a thin water-soluble layer is formed on the surface of the pigment particles in a manner known from chemical technology and general chemical industrial processes, which layer does not deteriorate the electrostatic characteristics of the particles, it may be provided for that a solution is formed partially on portions of the surface of the pigment particles encountering the liquid droplets 30, 31, 32. After the solution has dried, it fixes the pigment particles to one another and to the substrate surface.

This expediently organic glue (e.g. CMC) completely decomposes during firing, without leaving any trace on the image. The possibility of applying water or other liquids not containing solid additives for printing has enormous advantages compared even to common inkjet paints, while compared to such “problematic” materials as ceramic paints the advantages are very conspicuous. These latter materials have a number of disadvantageous characteristics, including very high density causing fast deposition, and high hardness that renders them strongly abrasive. Inkjet printers adapted for printing on paper carry out extensive cleaning operations before each printing session in order to remove solidified paint from each inkjet nozzle.

This nozzle cleaning step is not required in case of the liquid (e.g. distilled water) applied for the present invention, since the operation of the print head is not hindered by drying-in or by any change of the physical properties of the paint.

It is preferable for carrying out the method if
a liquid containing a slowly drying additive is applied;
a liquid containing an additive adjusting surface tension and/or viscosity is applied;
colour intensity may be adjusted by adjusting the spatial density of the liquid droplets;
the liquid is conveyed to the surface applying a fluid valve;
the liquid is conveyed to the surface applying fluid atomizer means;
such materials are applied wherein the powder chemically reacts with the liquid, the substrate, or with another powder material previously applied in a similar manner.

Removal of Non-Fixed Pigment Particles

The majority of the pigment particles are fixed to the target surface weakly, by electrostatic attraction, whereas in the printed-on areas they are fixed significantly more strongly (thanks to the partially dissolved and later dried gluing agent), and therefore applying suitable means it may be achieved that only those particles that are not making up the printed image are removed from the surface. If the specific surface area of the dye particles is reduced, e.g. by forming spherical particles through spray drying (atomiser technology) and adding suitable additives, then the adhesion between the particles as well as between particles and the substrate may be reduced significantly (in a manner similar that is applied in case of the toner powder of xerographic imaging devices).

Electrostatic adhesion may be further reduced, if necessary, by applying reversed-polarity charging (i.e. charge removal) in a manner similar to xerographic systems. Experience indicates that the non-fixed portion of the pigment particles may be easily removed from the surface by means of appropriately directed air blowing and extraction. The removed pigment may be recycled to the feeding container while the powder particles making up the fixed image stay on the surface, and thereby the final image is produced.

Advantages of the above described system compared to other inkjet methods:

It is of common knowledge among experts, but non-expert users of inkjet printers also know that the most frequently occurring faults of inkjet systems is caused by the ink “drying in”, i.e. when the ink, made up of a solid-liquid mixture, begins to lose its liquid content, “thickening” near the ejection location, which is followed by the partial or complete failure of the print head.

In our system, the dye and the glue components are combined with the liquid on the target surface, and thereby no such material enters the delicately constructed print head that would be prone to deposition, drying-in or to plugging the nozzles. Thus, the service life and reliability of the print head may be significantly increased. The industrial applicability of conventional inkjet systems can be maintained in a safe manner only by applying exceedingly complex technology, which leads to very high production and operation/maintenance costs.

Therefore, our system allows for the development of devices having lower costs. In certain fields of printing applications (e.g. ceramics) there are limitations to reducing the particle size of pigment. On the one hand, milling costs rise drastically as particle size decreases, and on the other hand certain materials lose their “colouring” ability if they are ground too fine. Applying the above described system, however, it is not required to radically modify the formulas and methods conventionally applied in ceramics technology for results having the generally required quality utilising a digital system. This is an extraordinary advantage in case of a fundamentally conservative industrial field that sticks to “tried and tested” technological knowledge so strongly as ceramics industry does.

1. A method for producing a digitally printed decorative coating on a solid surface, comprising the steps of:
applying solid pigment dye to the surface and treating the coating such that the treatment results in the setting/hardening of the coating,
wherein
first, the dry surface is evenly coated la applying solid pigment dye at least over the surface portion where the coating is to be applied,
in a subsequent printing operation liquid is applied to the surface coated with dry pigment dye, thereby temporarily fixing the solid pigment dye to the printed-on surface portions, and
before performing the treatment resulting in the setting/hardening of the coating, the non-fixed portion of the solid pigment dye is removed from the surface.

2. The method according to claim 1, wherein a liquid free from solid materials is utilized for the printing operation.

3. The method according to claim 1, wherein distilled water is utilized as a liquid for the printing operation.

4. The method according to claim 1, wherein the resulting color intensity is adjusted by adjusting the thickness of the pigment dye coating applied to the surface.

5. The method according to claim 1, wherein the dry pigment dye coating is applied to the surface by electrostatic powder spraying.

6. The method according to claim 1, wherein for the electrostatic powder spraying operation, the dry pigment dye is conveyed to the vicinity of the target surface applying compressed air.

7. The method according to claim 1, wherein a digitally prepared image is printed on the surface applying the liquid.

8. The method according to claim 1, wherein a layer soluble by the liquid is formed on the surface of the dry pigment dye particles, and the solid pigment is temporarily fixed to the surface portions utilizing a solution made from the soluble layer during the liquid printing operation.

9. The method according to claim 1, wherein the surface is subjected to drying before the treatment resulting in the setting/hardening thereof.

10. The method according to claim 1, wherein the liquid is conveyed to the surface utilizing an inkjet printer.

11. The method according to claim 1, wherein dry pigment dye powder particles that have not been fixed to the surface are removed by air blowing, the removed excess powder being returned to the feeder container.
